(19) United States
(12) Patent Application Publication
(10) Pub. No.: US 2004/0104308 A1
(43) Pub. Date: Jun. 3, 2004

(54) ATTITUDE CORRECTION OF DISTURBANCES RELATIVE TO A SPACECRAFT ATTITUDE SENSOR

(76) Inventor: YAT FAI LEUNG, REDWOOD CITY, CA (US)

Correspondence Address: JOYCE KOSINSKI, PATENT ADMINISTRATOR, LORAL SPACE AND COMMUNICATIONS, 655 DEEP VALLEY DRIVE SUITE 303, ROLLING HILLS ESTATES, CA, 90274

(21) Appl. No.: 09/333,607

(22) Filed: Jun. 15, 1999

(51) Int. Cl. B64G 1/36

(52) U.S. Cl. 244/171

(57) ABSTRACT

Systems and methods of controlling and correcting the attitude of a spacecraft or a spacecraft-based payload due to disturbances that cause attitude changes determined by a spacecraft attitude measurement sensor and one or more additional attitude measurement sensors on the spacecraft. The systems and methods measure the attitude of the spacecraft and measure relative attitude errors between the spacecraft and the payload. The measurements are processed to generate control signals that selectively control the pointing direction of the spacecraft or payload. Embodiments are disclosed wherein the additional attitude measurement sensor is disposed on a platform that is stable with respect to the spacecraft attitude measurement sensor, and wherein it is disposed on a platform that is not stable with respect to the spacecraft attitude measurement sensor. Another embodiment is disclosed having a plurality of spacecraft attitude measurement sensors, one each for the payload and for the spacecraft attitude measurement sensor.

### BACKGROUND

The present invention relates generally to spacecraft, and more particularly, to systems and methods that controls the attitude of a spacecraft relative to a spacecraft-based attitude sensor.

The assignee of the present invention manufactures and deploys spacecraft containing communications systems that orbit the earth. Such spacecraft have heretofore employed RF autotrack type controllers to control the attitude of the spacecraft.

Using an RF autotrack type controller requires a beacon on the earth and an RF sensor on the spacecraft to provide precise payload (antenna) pointing. This requires extra systems and complexity at the ground station and on the spacecraft.

In addition, unless there is an RF autotrack system for each pattern to be steered, the spacecraft structure is required to be thermally and mechanically stiff. The stiffness of the spacecraft structure is provided to account for slowly varying and fixed thermal and mechanical distortion between the spacecraft attitude sensor, such as a star tracker, for example, and the payload to precisely point the payload.

Therefore, it would be advantageous to have systems and methods that controls and corrects the attitude of a spacecraft relative to a spacecraft-based attitude sensor without requiring unnecessarily stiff spacecraft structures or additional systems and sensors, such as the beacon and RF sensor employed in RF autotrack systems.

### SUMMARY OF THE INVENTION

To meet the above and other objectives, the present invention provides for systems and methods of controlling and correcting the attitude of either a spacecraft body or a spacecraft-based payload due to disturbances that cause attitude changes determined by a spacecraft attitude measurement sensor and one or more additional attitude measurement sensors. The systems and methods measure the attitude of the spacecraft and measure relative attitude errors between the spacecraft and the payload.

The measurements are processes to generate control signals that selectively control the pointing direction of the spacecraft or payload. In certain embodiments, the additional attitude measurement sensor is disposed on a platform that is stable with respect to the spacecraft attitude measurement sensor. In another embodiment, the additional attitude measurement sensor is disposed on a platform that is not stable with respect to the spacecraft attitude measurement sensor. Another embodiment has a plurality of spacecraft attitude measurement sensors, one each for the payload and for the spacecraft attitude measurement sensor.

The present invention provides for improved pointing performance without requiring a signal source from the earth. The present invention also avoids the penalty of having a thermally and mechanically stiff spacecraft structure. Consequently, spacecraft distortion or non-ideal payload (antenna) actuation that adversely affect pointing are compensated for by the present invention using an onboard sensor that does not rely on an earth-based beacon.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a block diagram of a first embodiment of an exemplary system in accordance with the principles of the present invention;

FIG. 2 is a block diagram of a second embodiment of an exemplary system in accordance with the principles of the present invention;

FIG. 3 is a block diagram of a third embodiment of an exemplary system in accordance with the principles of the present invention; and

FIG. 4 is a diagram illustrating an exemplary method in accordance with the principles of the present invention.

### DETAILED DESCRIPTION

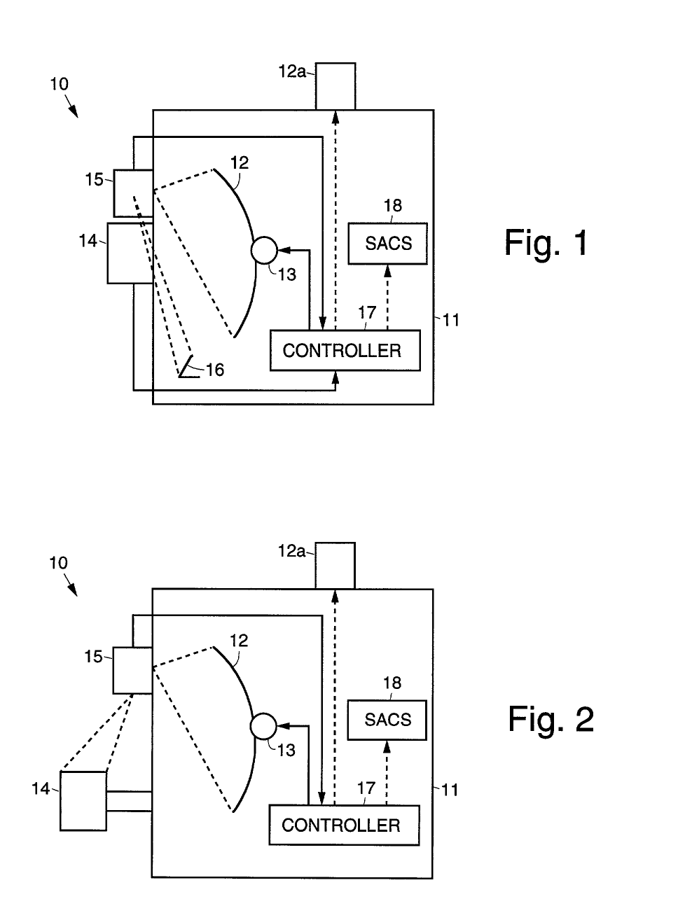

Referring to the drawing figures, FIG. 1 is a block diagram of a first embodiment of an exemplary system 10 in accordance with the principles of the present invention. The system 10 is disposed on a spacecraft 11 that comprises a payload 12 or antenna 12 that may be coupled to an actuator 13 that is used to point the payload 12 or antenna 12.

The first embodiment of the system 10 comprises a spacecraft attitude measurement sensor 14 and a remote attitude measurement sensor 15. The remote attitude measurement sensor 15 is disposed on a platform that is stable with respect to the spacecraft attitude sensor 14. The spacecraft attitude measurement sensor 14 is used to measure the attitude of the spacecraft 11.

The remote attitude measurement sensor 15 is used to measure the pointing direction or orientation of the antenna 12. The remote attitude measurement sensor 15 may also be used to measure the pointing direction a feed horn 16 for the antenna 12, if required. The remote attitude measurement sensor 15 detects relative attitude errors between the body of the spacecraft 11, the antenna 12 and the feed horn 16, if necessary.

The measurements made by the remote attitude measurement sensor 15 are made with respect to a known and fixed point on the spacecraft 11, such as the mounting location of the spacecraft attitude sensor 14, for example.

Outputs of the spacecraft attitude measurement sensor 14 and the remote attitude measurement sensor 15 are coupled to a controller 17. The controller 17 is used to process the measurements made by the spacecraft attitude measurement sensor 14 and remote attitude measurement sensor 15 and computes control signals that are sent to the actuator 13 that are used to control the pointing direction of the antenna 12.

Any payload 12 or device whose attitude with respect to the spacecraft attitude sensor 14 can be compensated for, such as an imager 12a, for example. Thus, the present invention is not limited to providing compensation for antennas 12, but has other uses as well.

The actuator 13 is controlled to move the beam transmitted by the antenna 12 to a desired pointing direction. The controller drives the antenna actuator 13 to correct for spacecraft body distortions or non-ideal antenna actuation using the measurements made by the spacecraft attitude measurement sensor 14 and the remote attitude measurement sensor 15.

FIG. 2 is a block diagram of a second embodiment of an exemplary system 10. FIG. 2 illustrates a system 10 that may be used in situations where the spacecraft attitude sensor 14 is not well-coupled to the remote attitude measurement sensor 15. In these situations, a remote sensor 15 that is coupled to the spacecraft attitude sensor 14 and that measures the pointing direction of the antenna 12 or payload 12 is used to measure the movement of the spacecraft attitude sensor 14. The remote attitude measurement sensor 15 is disposed on a platform that is not stable with respect to the spacecraft attitude sensor 14.

In the second embodiment of the system 10, the remote attitude measurement sensor 15 detects relative attitude errors between the body of the spacecraft 11 and the antenna 12 or payload 12. The remote attitude measurement sensor 15 provides the controller 17 with the information needed to properly point the payload 12, such as the antenna 12 and its beam.

In circumstances where there is only one critical beam pattern on the spacecraft 11, then the spacecraft 11 may be steered based on the combination of spacecraft attitude measurements and remote sensing measurements respectively made by the spacecraft attitude sensor 14 and the remote attitude measurement sensor 15. In these circumstances, the need for the actuator 13 is eliminated. The control signals output by the controller 17 are used to point the spacecraft 11. This is illustrated in FIGS. 1 and 2 by the dashed control line between the controller 17 and a spacecraft attitude control system (SACS) 18 that is used to point the spacecraft 11. Furthermore, the controller 17 may be used to compensate for thermal and mechanical attitude distortion between components that are referenced to the spacecraft attitude sensor 14.

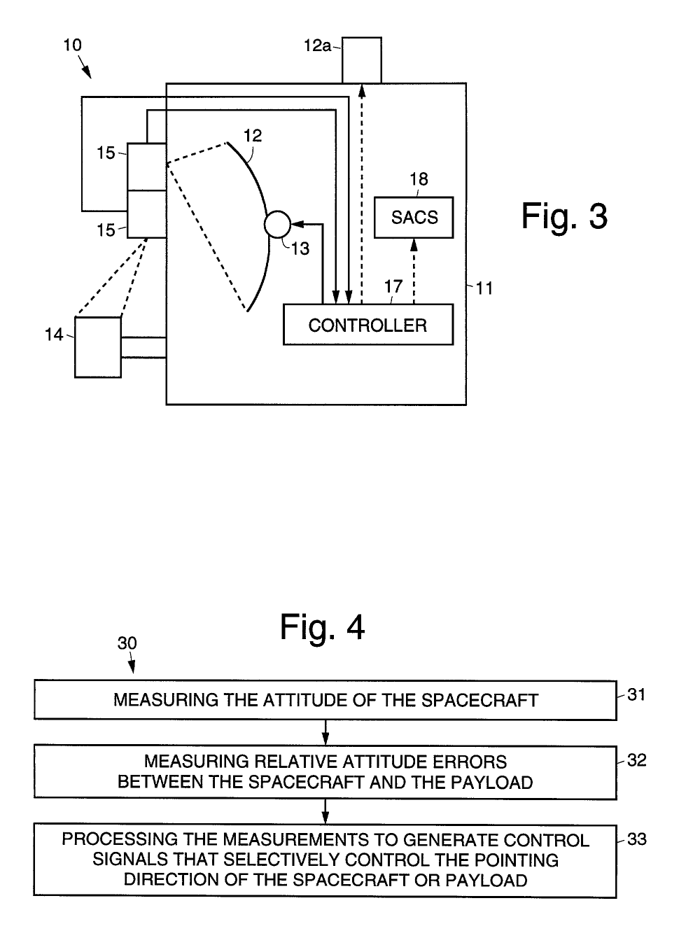

FIG. 3 is a block diagram of a third embodiment of an exemplary system 10 in accordance with the principles of the present invention. FIG. 2 illustrates a system 10 comprising a plurality of remote attitude measurement sensors 15. One remote attitude measurement sensor 15 is provided for the payload 12 and one remote attitude measurement sensor 15 is provided for spacecraft attitude sensor 14. The plurality of remote attitude measurement sensors 15 are coupled or tied together in the third embodiment of the system 10.

The present invention provides for improved pointing over non-RF autotrack systems without the overhead associated with an RF autotrack system. The present invention corrects the attitude of a spacecraft relative to a spacecraft-based attitude sensor without requiring unnecessarily stiff spacecraft structures or additional systems and sensors, such as the beacon and RF sensor employed in RF autotrack systems.

While the present invention does not provide the performance of an RF autotrack system, there are many situations where tight performance provided by the RF autotrack system is not required. Furthermore, the present invention is a much less expensive and more self contained approach that meets pointing requirements that fall between the performance of an RF autotrack system and a non-RF autotrack system.

For the purposes of completeness, and referring to FIG. 4, it is a diagram illustrating an exemplary method 30 in accordance with the principles of the present invention. The exemplary method 30 comprises the following steps. The attitude of the spacecraft are measured 31. Relative attitude errors between the spacecraft and the payload are measured 32. The measurements are processed 33 to generate control signals that selectively control the pointing direction of the spacecraft or payload.

Thus, systems and methods that correct the attitude of a spacecraft relative to a spacecraft-based attitude sensor have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A system for controlling the attitude of a spacecraft, or a payload on the spacecraft, comprising:
a spacecraft attitude measurement sensor for measuring the attitude of the spacecraft;
a remote attitude measurement sensor disposed on a platform that is stable with respect to the spacecraft attitude sensor for measuring relative attitude errors between the spacecraft and the payload; and
a controller coupled to the spacecraft attitude measurement sensor and the remote attitude measurement sensor for processing measurements made thereby to generate control signals that selectively control the pointing direction of the spacecraft or payload.

2. The system recited in claim 1 wherein the payload comprises an antenna, and the remote attitude measurement sensor measures relative attitude errors between the spacecraft and the antenna.

3. The system recited in claim 2 further comprising a feed horn for the antenna, and wherein the remote attitude measurement sensor detects relative attitude errors between the spacecraft, the antenna and the feed horn.

4. The system recited in claim 1 wherein the measurements made by the remote attitude measurement sensor are made with respect to a known and fixed point on the spacecraft.

5. The system recited in claim 4 wherein the measurements made by the remote attitude measurement sensor are made with respect to the mounting location of the spacecraft attitude sensor.

6. The system recited in claim 1 further comprising an actuator coupled to the payload, and wherein the controller generates control signals that are sent to the actuator that control the pointing direction of the payload.

7. The system recited in claim 1 further comprising a spacecraft attitude control system, and wherein the controller generates control signals that are sent to the spacecraft attitude control system that control the pointing direction of the spacecraft.

8. The system recited in claim 1 wherein the payload comprises an imager.

9. A system for controlling the attitude of a spacecraft, or a payload on the spacecraft, comprising:
a spacecraft attitude measurement sensor for measuring the attitude of the spacecraft;
a remote attitude measurement sensor disposed on a platform that is not stable with respect to the spacecraft attitude sensor for measuring relative attitude errors between the spacecraft and the payload; and
a controller coupled to the remote attitude measurement sensor for processing measurements made thereby to generate control signals that selectively control the pointing direction of the spacecraft or payload.

10. The system recited in claim 9 wherein the payload comprises an antenna, and the remote attitude measurement sensor measures relative attitude errors between the spacecraft and the antenna.

11. The system recited in claim 9 further comprising an actuator coupled to the payload, and wherein the controller generates control signals that are sent to the actuator that control the pointing direction of the payload.

12. The system recited in claim 9 further comprising a spacecraft attitude control system, and wherein the controller generates control signals that are sent to the spacecraft attitude control system that control the pointing direction of the spacecraft.

13. A system for controlling the attitude of a spacecraft, or a payload on the spacecraft, comprising:
a spacecraft attitude measurement sensor for measuring the attitude of the spacecraft;
a plurality of remote attitude measurement sensors for respectively measuring the attitude of the payload and the attitude of the spacecraft attitude sensor, which plurality of remote attitude measurement sensors are coupled together; and
a controller coupled to the spacecraft attitude measurement sensor and the plurality of remote attitude measurement sensors for processing measurements made 10 thereby to generate control signals that selectively control the pointing direction of the spacecraft or payload.

14. A method for controlling the attitude of a spacecraft, or a payload on the spacecraft, comprising the steps of:
measuring the attitude of the spacecraft;
measuring relative attitude errors between the spacecraft and the payload; and
processing the measurements to generate control signals that selectively control the pointing direction of the spacecraft or payload.

15. The method recited in claim 14 wherein the payload comprises an antenna, and wherein the measuring step comprises measuring relative attitude errors between the spacecraft and the antenna.

16. The method recited in claim 15 wherein the payload further comprises a feed horn for the antenna, and wherein the measuring step comprises measuring relative attitude errors between the spacecraft, the antenna and the feed horn.

17. The method recited in claim 14 wherein the measuring step comprises measuring relative attitude errors with respect to a known and fixed point on the spacecraft.

18. The method recited in claim 17 wherein the measuring step comprises measuring relative attitude errors with respect to the mounting location of a spacecraft attitude sensor.

19. The method recited in claim 14 wherein the payload is coupled to an actuator, and wherein the processing step comprises generating control signals that are sent to the actuator to control the pointing direction of the payload.

20. The method recited in claim 14 wherein the spacecraft further comprises a spacecraft attitude control system, and wherein the processing step comprises generating control signals that are sent to the spacecraft attitude control system that control the pointing direction of the spacecraft.
